(19) United States
(12) Patent Application Publication
(10) Pub. No.: US 2026/0066371 A1
(43) Pub. Date: Mar. 5, 2026

(54) CYLINDRICAL BATTERY SORTING SYSTEM

(71) Applicant: Industrial Technology Research Institute, Hsinchu (TW)

(72) Inventors: Feng-Sheng Kao, Hsinchu City (TW); Jen-You Chu, Hsinchu City (TW); Cheng-Lin Li, Taoyuan City (TW); Jr-Chiun Yu, New Taipei City (TW); Yi-Chen Chen, Hsinchu County (TW)

(73) Assignee: Industrial Technology Research Institute, Hsinchu (TW)

(21) Appl. No.: 18/983,364

(22) Filed: Dec. 17, 2024

Related U.S. Application Data
(60) Provisional application No. 63/688,878, filed on Aug. 30, 2024.

(51) Int. Cl. H01M 10/54; G06V 10/12; H01M 50/107

(52) U.S. Cl. CPC H01M 10/54; G06V 10/12; H01M 50/107; G06V 2201/06; G06V 2201/09

(57) ABSTRACT

A cylindrical battery sorting system includes a host, a conveying device, a sorting device, an acceleration device, and a camera device. The conveying device is electrically connected to the host, includes rollers disposed side by side, and has a feeding area, an acceleration area, and a sorting area. The sorting device is electrically connected to the host and disposed corresponding to the sorting area. The acceleration device is electrically connected to the host and disposed in the acceleration area. The camera device is electrically connected to the host and disposed corresponding to the acceleration area. When a battery enters a capturing area, the camera device moves synchronously with rolling of the battery to capture an image of the rolling battery, and transmit the image back to the host to determine type of the battery. The sorting device places the battery into a corresponding recycling area according to the captured image.

### CROSS-REFERENCE TO RELATED APPLICATION

This application claims the priority benefit of U.S. Provisional Application No. 63/688,878, filed on Aug. 30, 2024. The entirety of the above-mentioned patent application is hereby incorporated by reference herein and made a part of this specification.

### TECHNICAL FIELD

The disclosure relates to a sorting system, and in particular to a cylindrical battery sorting system.

### BACKGROUND

High-priced metals such as lithium, nickel, cobalt, and manganese in waste batteries have extremely high recycling value. The current recycling of batteries is to undergo manual rough classification and then be sent directly to foreign countries for processing, or the batteries may be crushed to generate black powder and then become downgraded materials. Nowadays, black gold benefits brought by black powder regeneration technology have promoted the development of battery sorting technology.

Although there is currently research and development of image recognition technology for batteries, the accuracy is only 80%, which is close to human eye recognition and cannot achieve true fine sorting.

Although a few manufacturers invest in high-priced X-ray machines for general battery classification, the X-ray machines cannot distinguish lithium batteries and types, and the cost performance ratio is low.

Therefore, there is a need to develop cost-effective, highly accurate, and easy sorting technology to solve the issue of classification costs to improve the operational efficiency of the entire recycling system.

The cheaper and cleaner the front-stage classification of discarded batteries is, the easier it will be to implement the back-stage low-carbon regeneration technology, allowing the entire recycling chain to run smoothly.

Most lithium battery modules are cylindrical battery stacks after being disassembled, and general small batteries for daily use are also cylindrical, so cylindrical waste batteries are the largest item to be processed in battery recycling.

### SUMMARY

A cylindrical battery sorting system capable of accurate classification is introduced herein.

A cylindrical battery sorting system of the disclosure includes a host, a conveying device, a sorting device, an acceleration device, and a camera device. The conveying device is electrically connected to the host, the conveying device includes multiple rollers disposed side by side, and the conveying device has a feeding area, an acceleration area, and a sorting area. The sorting device is electrically connected to the host and is disposed corresponding to the sorting area. The acceleration device is electrically connected to the host and is disposed in the acceleration area. The rollers located in the feeding area rotate at a first speed, and the rollers located in the acceleration area rotate at a second speed greater than the first speed. The camera device is electrically connected to the host and is disposed corresponding to the acceleration area. When a battery enters a capturing area in the acceleration area, the camera device moves synchronously with movement of the battery to capture an image of the rolling battery, and transmits the image back to the host to determine a type of the battery, and the sorting device correspondingly places the battery into a corresponding recycling area according to the captured image.

Based on the above, the cylindrical battery sorting system of the disclosure can effectively and accurately sort cylindrical batteries, thereby improving recycling efficiency.

Several exemplary embodiments accompanied with drawings are described in detail below to further describe the disclosure in detail.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic block view of a cylindrical battery sorting system according to an embodiment of the disclosure.

FIG. 2 is a schematic view of the cylindrical battery sorting system of FIG. 1.

FIG. 3 is a schematic top view of the cylindrical battery sorting system of FIG. 1 (with a camera device omitted).

FIG. 4 is a partial side view of the cylindrical battery sorting system of FIG. 1.

FIG. 5 is a complete label image of a battery obtained by a camera device.

### DETAILED DESCRIPTION OF DISCLOSURED EMBODIMENTS

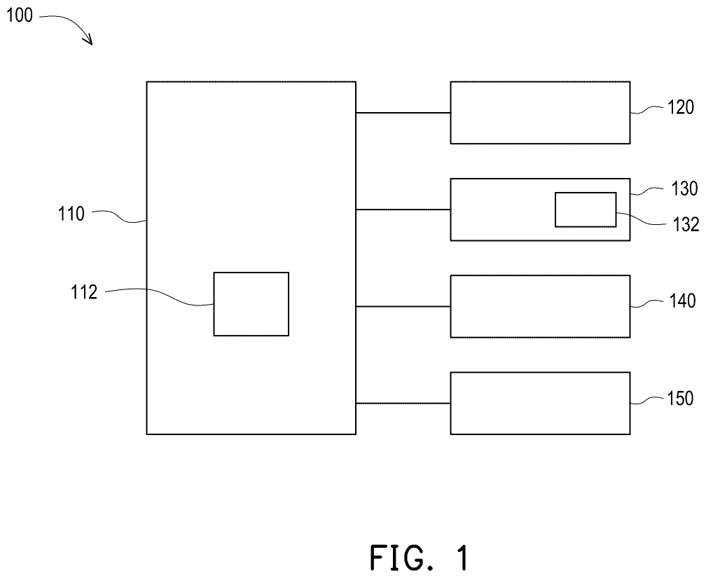

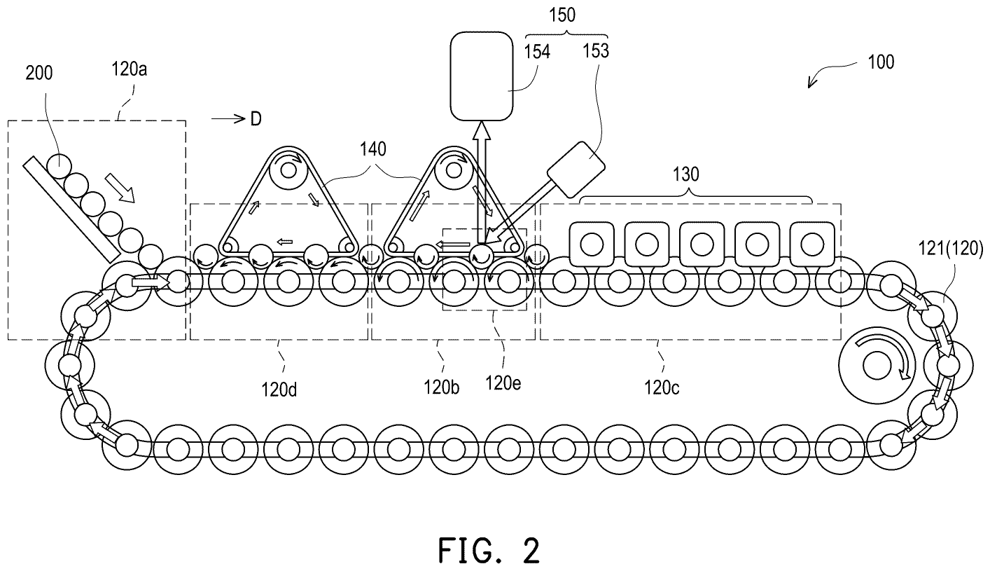

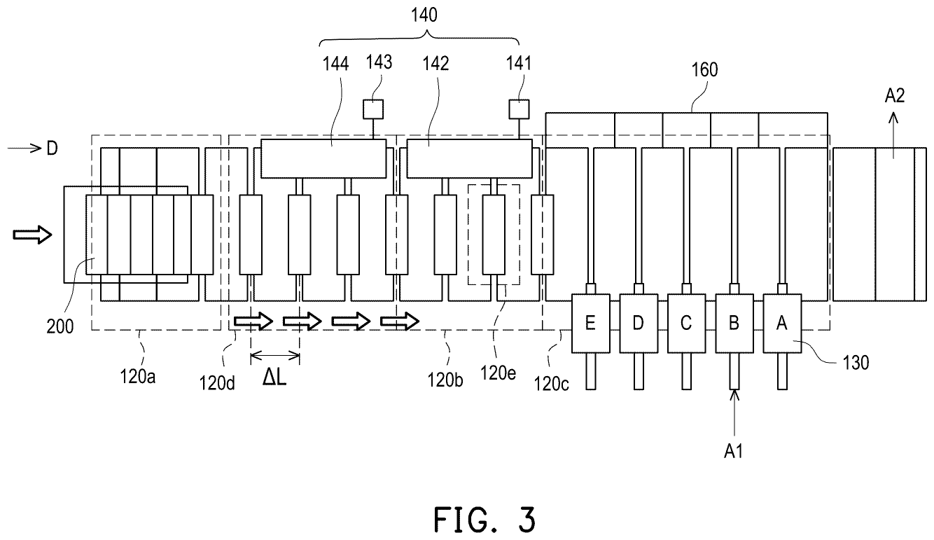

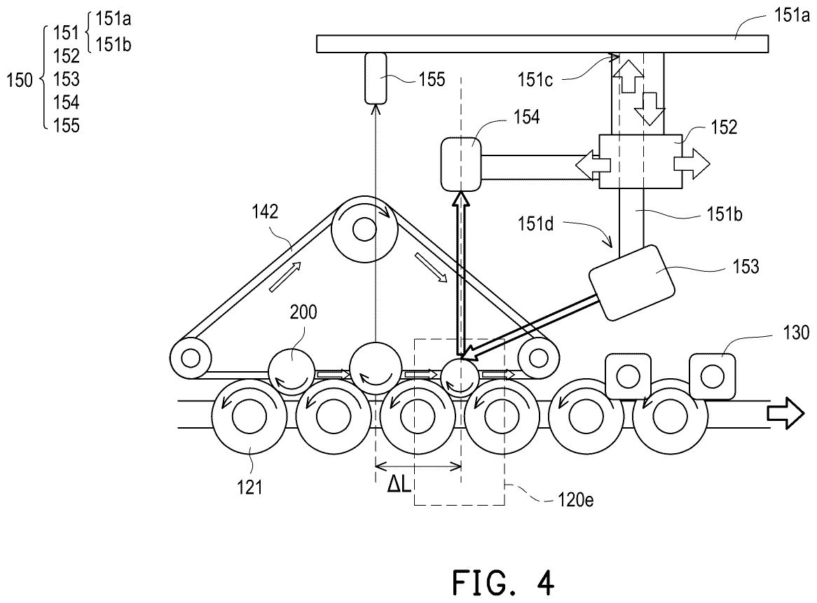

FIG. 1 is a schematic block view of a cylindrical battery sorting system according to an embodiment of the disclosure, FIG. 2 is a schematic view of the cylindrical battery sorting system of FIG. 1, FIG. 3 is a schematic top view of the cylindrical battery sorting system of FIG. 1 (with a camera device omitted), and FIG. 4 is a partial side view of the cylindrical battery sorting system of FIG. 1.

Please refer to FIG. 1, FIG. 2, and FIG. 3 at the same time. A cylindrical battery sorting system 100 of the embodiment includes a host 110, a conveying device 120, a sorting device 130, an acceleration device 140, and a camera device 150, wherein the conveying device 120, the sorting device 130, the acceleration device 140, and the camera device 150 are all electrically connected to the host 110.

Please refer to FIG. 2, FIG. 3, and FIG. 4 at the same time. The conveying device 120 includes multiple rollers 121 disposed side by side, wherein the rollers 121 have the same shape and size. Specifically, the diameter of the roller 121 of the embodiment ranges from 1 cm to 10 cm, the length of the roller 121 ranges from 5 cm to 20 cm, and a gap between any two adjacent rollers 121 ranges from 2 mm to 40 mm.

The conveying device 120 is divided into a feeding area 120a, an acceleration area 120b, and a sorting area 120c, wherein the rollers 121 located in each area rotate at the same speed, but the rollers 121 located in different areas rotate at different speeds.

Specifically, the rollers 121 located in the feeding area 120a rotate at a first speed, and the rollers 121 located in the acceleration area 120b rotate at a second speed, wherein the second speed is greater than the first speed.

In addition, the conveying device 120 may also have a buffer area 120d located between the feeding area 120a and the acceleration area 120b, wherein the rollers 121 correspondingly located in the buffer area 120d rotate at a third speed, and the third speed is greater than the first speed but less than the second speed.

The sorting device 130 is disposed corresponding to the sorting area 120c, the acceleration device 140 is disposed corresponding to the acceleration area 120b, and the camera device 150 is disposed corresponding to the acceleration area 120b.

The sorting device 130 may be composed of multiple air blowing members, multiple push rods, a robotic arm, or a combination thereof. The disposition of the sorting device 130 does not interfere with rolling of the rollers 121 of the conveying device 120.

In the embodiment, the push rods are selected as the sorting device 130 to sort batteries entering the sorting area 120c, wherein an axial direction A1 of the push rods is parallel to an axial direction A2 of the rollers 121.

In other embodiments not shown, the air blowing members may also be selected to sort the batteries entering the sorting area 120c, wherein an air blowing direction of the air blowing members is parallel to the axial direction A2 of the rollers 121.

In addition, in other embodiments not shown, the multi-directional robotic arm may also be selected for picking and sorting, wherein since the robotic arm is multi-directional, there are fewer limitations of disposition.

The push rods, the air blowing members, and the mechanical arm may also be used in combination.

The acceleration device 140 disposed corresponding to the acceleration area 120b includes a first motor 141 and a first belt 142, wherein the first belt 142 is connected to the rollers 121 correspondingly disposed in the acceleration area 120b, so that the first motor 141 may drive the rollers 121 disposed in the acceleration area 120b to rotate at the second speed via the first belt 142.

In addition, the acceleration device 140 further includes a second motor 143 and a second belt 144. The second belt 144 is connected to the rollers 121 correspondingly disposed in the buffer area 120d, and the second motor 143 drives the rollers 121 correspondingly disposed in the buffer area 120d to rotate at the third speed via the second belt 144.

The disposition of the buffer area 120d serves as a speed buffer between the feeding area 120a and the acceleration area 120b, so that the speed increase of a transportation process of batteries after passing through the feeding area 120a and the buffer area 120d and entering the acceleration area 120b is in stages to prevent the batteries from jumping due to an excessive speed difference between the feeding area 120a and the acceleration area 120b, so as to prevent a battery 200 from suddenly entering a capturing area 120e, but the camera device 150 is not ready for capturing or prevent the battery 200 from jumping in irregular directions and jumping out of the acceleration area 120b without entering the acceleration area 120b according to a preset path.

Therefore, the feeding area 120a and the acceleration area 120b are not limited to being provided with only one buffer area 120d, but can be provided with multiple buffer areas 120d, and along a feeding direction D, the speed of the rollers 121 in the buffer areas 120d arranged from adjacent to the feeding area 120a toward the acceleration area 120b gradually increases.

Please continue to refer to FIG. 2, FIG. 3, and FIG. 4 at the same time. The camera device 150 includes a fixed bracket 151, a moving module 152, a line light source 153, and a line scan camera 154. The fixed bracket 151 includes a horizontal rod 151a and a vertical rod 151b, wherein the horizontal rod 151a is disposed above the conveying device 120 corresponding to the capturing area 120e, and a first end 151c of the vertical rod 151b is connected to the horizontal rod 151a. The moving module 152 is movably disposed on the vertical rod 151b relative to the vertical rod 151b. The line light source 153 is disposed at a second end 151d of the vertical rod 151b away from the horizontal rod 151a. The line scan camera 154 is fixed on the moving module 152 and is driven by the moving module 152 to be close to or away from the line light source 153, wherein the high-speed line scan camera 154 may be selected.

Although the above description takes the line scan camera 154 and the line light source 153 as being individually independent as an example, in an embodiment, the line scan camera 154 and the line light source 153 may also be designed to be integrated, that is, the line scan camera 154 and the line light source 153 may synchronously move up, down, forward, and backward through the moving module 152.

In addition, the camera device 150 further includes a rangefinder 155 fixed on the horizontal rod 151a. The rangefinder 155 is configured to measure a distance from the battery 200 entering the capturing area 120e, and provide a measurement result to the host 110. After computation by the host 110, the moving module 152 is controlled to adjust a position of the line scan camera 154.

The following will describe a process of recycling the discarded cylindrical battery 200 using the cylindrical battery sorting system 100, wherein the cylindrical battery 200 is, for example, an alkaline battery, a carbon zinc battery, a nickel cadmium battery, a nickel hydrogen battery, a lithium iron phosphorus battery, a lithium manganese oxygen battery, etc.

In the following description, the cylindrical battery 200 is also referred to as the battery 200 for short.

Please refer to FIG. 2, FIG. 3, and FIG. 4 at the same time. When recycling the discarded cylindrical batteries 200 using the cylindrical battery sorting system 100, the batteries 200 are continuously or intermittently fed in rows from the feeding area 120a.

The battery 200 is rotated by the rolling of the rollers 121 while advancing along the feeding direction D, passing through the buffer area 120d, and entering the capturing area 120e of the acceleration area 120b.

After the battery 200 enters the capturing area 120e, the battery 200 rotates 0.5 to 2 rounds in the capturing area 120e, and the duration (that is, the rotation time) is about 0.01 to 1 second. Specifically, the rollers 121 rotate, so that the battery 200 advances for a unit length of time or the time for the battery 200 to complete an intermittent advance is Δt, where Δt is 0.01 second to 1 second. A separation distance between any two adjacent rollers 121 is a unit distance ΔL, ΔL ranges from 2 cm to 15 cm, and the battery 200 rotates 0.5 to 2 rounds in the unit distance ΔL.

The camera device 150 moves synchronously with the rolling and movement of the battery 200 to capture an image of the rolling battery 200.

Specifically, when the cylindrical battery 200 reaches a previous unit distance from a detection position (x=0) of the line scan camera 154, the rangefinder 155 measures the distance from the cylindrical battery 200, and the vertical moving module 152 is driven according to the measurement result, so that the line scan camera 154 and the line light source 153 move to an optimal detection focal length when the cylindrical battery 200 reaches the detection position (x=0).

When the cylindrical battery 200 reaches the detection position (x=0), the moving module 152 moves forward at the same speed as the moving speed of the battery 200, so that the line scan camera 154 maintains the same relative distance with the line light source 153 and the cylindrical battery 200.

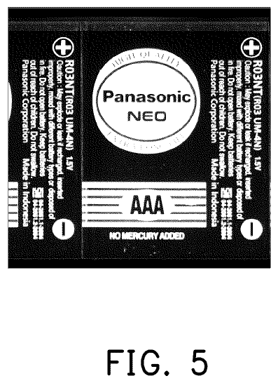

After the cylindrical battery 200 rotating at the same speed is sent into the capturing area 120e, line scan is completed in a fixed time. The scanning time is the time for the cylindrical battery 200 to completely rotate one to two rounds, and the time is 0.01 seconds to 1 second, so as to obtain a complete label image of the battery 200 as shown in FIG. 5.

After scanning the complete label image, the moving module 152 moves horizontally, so that the line scan camera 154 returns to the detection position (x=0).

Please refer to FIG. 1, FIG. 3, and FIG. 4 at the same time. At the same time, the image is sent back to the host 110 to determine the type of the battery 200. The host 110 of the embodiment has an image recognition device 112 for converting an image into characters or calculating image features for classification and determination, wherein the image recognition device 112 includes a computer computing system, a text recognition algorithm, an image recognition algorithm, an image processing algorithm, and/or a battery label information database. The image sent to the host 110 is analyzed and determined by the image recognition device 112. The image recognition device 112 converts the image into characters or calculates the image features of the image, and analyzes feature information of the battery 200, wherein the feature information includes brand, model, size, weight, color, battery characteristics, serial number, trademark, barcode, etc.

After that, through comparing with the battery label information database, a classification algorithm is used to classify the brand of the battery 200. The classification algorithm may be various algorithms, such as YOLO, CNN, fast R-CNN, CTPN, EAST, CSPNet, LPRNet, U-Net, Resnet, EfficientNet, ArcFace, DINO, and Siamese Networks.

Then, the sorting device 130 correspondingly places the battery 200 into a corresponding recycling area 160, such as a classification basket, according to the captured image.

In the embodiment, the classification information obtained from the image recognition device 112 corresponds to a sorting position classified according to the type of the battery 200, so as to calculate when the push rod (the sorting device 130) takes action. Specifically, the sorting device 130 further includes a programmable logic controller 132 for controlling the push rod, and generates a signal to drive the push rod to operate according to the classification information obtained from the image recognition device 112. When the battery 200 is classified into a type A by the image recognition device 112, and the push rod of the classification basket corresponding to the type A is n unit distances away from an image capturing system, the programmable logic controller 132 of the cylindrical battery sorting system 100 generates the signal to drive the push rod of the type A to operate at a time after Δt*n to push the battery 200 located in the sorting area 120c into the classification basket, so as to achieve sorting.

In summary, the cylindrical battery sorting system of the disclosure may prevent the cylindrical battery from jumping due to an excessive speed difference when entering from one area to another through the multi-stage speed increase (the feeding area, the buffer area, and the acceleration area).

In addition, through the disposition of the moving module, the movement of the line scan camera is synchronized with the movement of the battery. Therefore, the complete label image of the battery may be obtained, instead of obtaining a label image by splicing and then determining. Therefore, the accuracy of the image is effectively improved, thereby improving classification accuracy.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A cylindrical battery sorting system, comprising:
a host;
a conveying device, electrically connected to the host, the conveying device comprising a plurality of rollers disposed side by side, and the conveying device having a feeding area, an acceleration area, and a sorting area;
a sorting device, electrically connected to the host and disposed corresponding to the sorting area;
an acceleration device, electrically connected to the host and disposed in the acceleration area, wherein the rollers located in the feeding area rotate at a first speed, the rollers located in the acceleration area rotate at a second speed, and the second speed is greater than the first speed; and
a camera device, electrically connected to the host and disposed corresponding to the acceleration area,
wherein when a battery enters a capturing area in the acceleration area, the camera device moves synchronously with movement of the battery to capture an image of the rolling battery, and transmits the image back to the host to determine a type of the battery, and the sorting device correspondingly places the battery into a corresponding recycling area according to the captured image.

2. The cylindrical battery sorting system according to claim 1, wherein the sorting device comprises a plurality of push rods, a robotic arm, a plurality of air blowing members, or a combination thereof.

3. The cylindrical battery sorting system according to claim 2, wherein an axial direction of the push rods is parallel to an axial direction of the rollers.

4. The cylindrical battery sorting system according to claim 2, wherein an air blowing direction of the air blowing members is parallel to an axial direction of the rollers.

5. The cylindrical battery sorting system according to claim 1, wherein the acceleration device comprises a first motor and a first belt, the first belt is connected to the rollers correspondingly disposed in the acceleration area, and the first motor drives the rollers disposed in the acceleration area to rotate at the second speed via the first belt.

6. The cylindrical battery sorting system according to claim 5, further comprising a buffer area disposed between the feeding area and the acceleration area, wherein the rollers located in the buffer area rotate at a third speed, and the third speed is greater than the first speed and less than the second speed.

7. The cylindrical battery sorting system according to claim 6, wherein the acceleration device further comprises a second motor and a second belt, the second belt is connected to the rollers correspondingly disposed in the buffer area, and the second motor drives the rollers correspondingly disposed in the buffer area to rotate at the third speed via the second belt.

8. The cylindrical battery sorting system according to claim 1, wherein the camera device comprises:
a fixed bracket, comprising a horizontal rod and a vertical rod, wherein the horizontal rod is disposed above the conveying device corresponding to the capturing area, and a first end of the vertical rod is connected to the horizontal rod;
a moving module, movably disposed on the vertical rod relative to the vertical rod;
a line light source, disposed at a second end of the vertical rod away from the horizontal rod; and
a line scan camera, fixed on the moving module and driven by the moving module to move.

9. The cylindrical battery sorting system according to claim 8, wherein the line light source and the line scan camera are designed to be integrated and to move synchronously.

10. The cylindrical battery sorting system according to claim 8, wherein the camera device further comprises a rangefinder fixed on the horizontal rod.

11. The cylindrical battery sorting system according to claim 1, wherein the battery rotates 0.5 to 2 rounds in the capturing area.

12. The cylindrical battery sorting system according to claim 11, wherein a rotation time of the battery in the capturing area is 0.01 to 1 second.

13. The cylindrical battery sorting system according to claim 1, wherein the host has an image recognition device converting the image into characters or calculating image features for classification and determination.

14. The cylindrical battery sorting system according to claim 13, wherein the image recognition device comprises a computer computing system, a text recognition algorithm, an image recognition algorithm, an image processing algorithm, or a battery label information database.

15. The cylindrical battery sorting system according to claim 13, wherein the image recognition device converts the image into characters or calculates the image features of the image, and analyzes feature information of the battery.

16. The cylindrical battery sorting system according to claim 13, wherein the image recognition device uses a classification algorithm to classify the battery by brand.

17. The cylindrical battery sorting system according to claim 1, wherein the battery continuously or intermittently enters the feeding area of the conveying device.

18. The cylindrical battery sorting system according to claim 1, wherein the rollers rotate, so that the battery advances by a unit length of time, or a time for the battery to complete an intermittent advance is Δt, where Δt is 0.01 seconds to 1 second, and a separation distance between any adjacent two of the rollers is a unit distance ΔL, and ΔL ranges from 2 cm to 15 cm.

19. The cylindrical battery sorting system according to claim 1, wherein a diameter of the rollers ranges from 1 cm to 10 cm, a length of the rollers ranges from 5 cm to 20 cm, and a gap between any adjacent two of the rollers ranges from 2 mm to 40 mm.
